(19) United States
(12) Patent Application Publication
(10) Pub. No.: US 2011/0180493 A1
(43) Pub. Date: Jul. 28, 2011

(54) DEVICE AND METHOD FOR PROCESSING A COOLING AND RINSING LIQUID

(75) Inventors: Georg Holzmeier, Untermeitingen (DE); Pfeiffer Ralf, Landsberg (DE); Marc Schuster, Karlsruhe (DE); Andreas Burkhard, Schwabmuenchen (DE)

(73) Assignee: Hilti Aktiengesellschaft, Schaan (LI)

(21) Appl. No.: 12/972,246

(22) Filed: Dec. 17, 2010

(30) Foreign Application Priority Data
Dec. 18, 2009 (DE) 10 2009 054 962.5

(51) Int. Cl. B01D 35/02; B01D 37/00; B01D 29/60

(52) U.S. Cl. 210/767; 210/167.01; 210/97

(57) ABSTRACT

A device and method for processing a cooling and rinsing liquid from a dirty liquid is disclosed. The device includes a first container, which is connected to a feed line for the dirty liquid, a second container, which is connected to a discharge line for the process cooling and rinsing liquid, and a filter element which is arranged in the second container. A connecting line connects the first and second containers and a bypass line connects the discharge line to the connecting line.

This application claims the priority of German Patent Document No. 10 2009 054 962.5, filed Dec. 18, 2009, the disclosure of which is expressly incorporated by reference herein.

### BACKGROUND AND SUMMARY OF THE INVENTION

The present invention relates to a device for processing a cooling and rinsing liquid a method for processing a cooling and rinsing liquid.

In abrasive machining using diamond tools, for example, in the form of diamond core bits or diamond saws, it is necessary to cool the diamond tool in the area of the machining location to prevent damage to the diamond tool due to overheating. The cutting segments of the diamond tools are cooled by a cooling liquid during the machining operation to support the machining operation and to increase the lifetime of the cutting segments. The liquid also serves to remove the solids cut away by the diamond tool from the machining site. The liquid supplied is referred to as cooling and rinsing liquid; the liquid mixed with solids is referred to as dirty liquid.

European Patent Document No. EP 0 941 828 B1 discloses a known processing device for processing a cooling and rinsing liquid from a dirty liquid and for supplying the recycled cooling and rinsing liquid to a machine tool, for example, a core drilling device. The processing device comprises two containers that are sealed to be airtight and fluid-tight. The first container is designed as a vacuum container by means of a vacuum mechanism during operation, and the second container is designed as a pressurized container by means of a pressurized mechanism. The vacuum container is connected by a connecting line to the pressurized container. With the help of the vacuum mechanism, the dirty liquid is drawn through a supply line into the vacuum container, which also serves to preclean the dirty liquid. The pressurized device which is situated in the connecting line conveys the precleaned dirty liquid out of the vacuum container through the connecting line into the pressurized container. A filter element which is in contact with the precleaned dirty liquid on the outside is located on the cover of the pressurized container. Because of the high pressure, the precleaned dirty liquid flows into the interior of the filter element. Solids present in the precleaned dirty liquid are captured in the filter element. Recycled cooling and rinsing liquid, which can be supplied to the machine tool, collects in the interior of the filter element. Because of the high pressure, the recycled cooling and rinsing liquid flows through a supply line to the machine tool.

The dirty liquid and/or the precleaned dirty liquid flow(s) through the feed line, the connecting line and the pressurized line. Both the dirty liquid and the precleaned dirty liquid contain solids that can clog up the lines and the high-pressure mechanism. To ensure the functionality of the processing device and to make available a sufficient amount of cooling and rinsing liquid, it is necessary to regularly clean the lines and the high-pressure mechanism and to remove the solids.

Operation of the known processing device provides for the containers to be cleaned before any prolonged pause in operation and after the end of each work day and for the filter element to be regenerated. The known processing device has the disadvantage that the feed line, the connecting line and the high-pressure mechanism can be cleaned manually by the operator and there is no automatic cleaning operation.

The object of the present invention thus consists of further developing a device and a method for processing a cooling and rinsing liquid of the type defined in the introduction to the extent that the functionality of the processing device is improved and the risk of blockage of the processing device is reduced.

A device for processing a cooling and rinsing liquid from a dirty liquid, comprising a first container, which is connected to a feed line for the dirty liquid, a second container, which is connected to a discharge line for the process cooling and rinsing liquid, a filter element, which is arranged in the second container, and a connecting line, which connects the first and second containers.

According to the invention, a bypass line is provided, connecting the discharge line to the connecting line. The bypass line preferably has a control valve, such that the control valve is adjustable by a control mechanism between an open state, in which flow can pass through the control valve, and a closed state, in which the flow cannot pass through the control valve.

In a preferred embodiment, a control valve, which is adjustable by a control mechanism between an open state, in which flow can pass through the control valve, and a closed state, in which no flow can pass through the control valve, is provided in the discharge line, such that the control valve is arranged downstream from the bypass line in one direction of flow. With the help of the control valve, the supply of cooling and rinsing liquid to the core drilling device can be interrupted, so that the cooling and rinsing liquid can be used for cleaning.

In another preferred embodiment, the second container cooperates with a high-pressure device, which is arranged in the connecting line, and the bypass line opens into the connecting line upstream from the high-pressure device in one direction of flow. This arrangement ensures that the high-pressure device is cleaned.

In a further preferred embodiment, another bypass line is provided, so that the connecting line is connected to the feed line. The additional bypass line especially preferably has a control valve, such that the control valve is adjustable by a control mechanism between an open state, in which flow can pass through the control valve, and a closed state, in which no flow can pass through the control valve.

In another preferred embodiment, the filter element is arranged upstream from the second container in one direction of flow. This embodiment has the advantage that the solids filtered out of the filter element are in the interior of the filter element.

In an alternative preferred embodiment, the filter element is arranged downstream from the second container in one direction of flow.

A pressure switch for measuring the pressure and/or a diaphragm pressure reservoir is/are preferably provided in the discharge line. The pressure switch makes it possible to automatically release, by the control mechanism, the cooling and rinsing liquid stored in the diaphragm pressure reservoir on exceeding a pressure value. The cooling and rinsing liquid stored in the diaphragm pressure reservoir is especially suitable for cleaning the filter element.

Furthermore, a method for processing a cooling and rinsing liquid in a processing device is provided, in which a control valve on the active high-pressure device is closed and a bypass line is opened via the control valve for an interval of time. The control valve in the discharge line interrupts the supply of cooling and rinsing liquid to the core drilling device. The cooling and rinsing liquid is diverted via the opened bypass line into the connecting line. In this way, the connecting line and the high-pressure device arranged in the connecting line are cleaned with the help of the cooling and rinsing liquid.

Additional advantages and advantageous embodiments of the subject matter of the invention can be derived from the description and the drawings. Likewise, the aforementioned features, which are also discussed further below, may be used individually by themselves or combined in multiples in any combination according to the invention. The embodiments described and illustrated here are not to be understood as an exclusive enumeration but instead have the character of examples to illustrate the invention.

### BRIEF DESCRIPTION OF THE DRAWINGS

FIG. 1 illustrates a core drilling device, having a first embodiment of an inventive processing device for processing a cooling and rinsing liquid; and

FIG. 2 illustrates the core drilling device from FIG. 1, having a second embodiment of an inventive processing device for processing a cooling and rinsing liquid.

### DETAILED DESCRIPTION OF THE DRAWINGS

The same elements or those having the same function are identified by the same reference numerals in the figures, unless otherwise indicated.

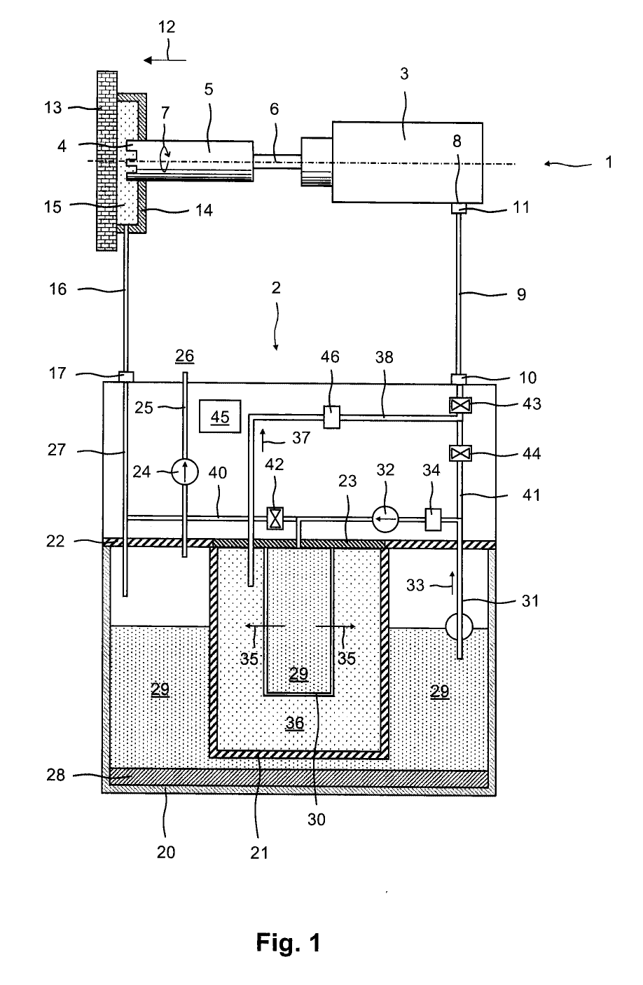

The machine tool shown in FIG. 1 is designed as a core drilling device 1 and is connected to an inventive processing device 2 for processing a cooling and rinsing liquid.

The core drilling device 1 comprises a machine unit 3, which drives a core bit 5 comprising cutting segments 4 in a direction of rotation 7 about an axis 6 of rotation. The cooling and rinsing liquid is supplied to the machine unit 3 through an inlet opening 8. The inlet opening 8 is connected to an outlet connection 10 of the processing device 2 via a supply line 9. Alternatively, the cooling and rinsing liquid may be sent to a suction and/or rinse head, which is arranged downstream from the machine unit 3 in the direction of flow.

The flow of cooling and rinsing liquid into the machine unit 3 is adjustable by a regulating device 11, which is connected to the inlet opening 8 of the machine unit 3 and is operated manually by an operator. The regulating device 11 is designed as a cutoff device and is adjustable between an open position, in which the cooling and rinsing liquid can flow into the machine unit 3, and a closed position, in which the supply of cooling and rinsing liquid to the machine unit 3 is interrupted. Alternatively, the regulating device 11 may enable a discrete or continuous adjustment of the flow of cooling and rinsing liquid between 0% (closed position) and 100% (open position).

In a drilling operation, i.e., while the core bit 5 is driven to rotate about the axis of rotation 6 and the cutting segments 4 penetrate into a substrate 13 to be machined in one drilling direction 12, the core bit 5 is rinsed by the cooling and rinsing liquid and cooled in the area of the machining site. A collecting device 14 is arranged on the substrate 13 to be machined, so that it surrounds the machining site and collects a heated cooling and rinsing liquid, which is mixed with solids and is referred to as dirty liquid 15. The collecting device 14 is connected to an input connection 17 of the processing device 2 via a suction line 16.

The processing device 2 comprises a first container 20 and a second container 21. To design the processing device 2 to be compact, the second container 21 is arranged in the first container 20, and both containers 20, 21 are sealed to be airtight and fluid-tight by one cover 22, 23 each. Alternatively, the two containers 20, 21 may be arranged side by side.

In a drilling operation, the first container 20 cooperates with a suction device 24, which conveys the dirty liquid 15 out of the collecting device 14 into the first container 20. The suction device 24 is designed, for example, as a device for generating a vacuum, which is referred to below as a vacuum device, and the first container 20 is also referred to as a vacuum container. The vacuum device 24 is arranged in a suction line 25, which opens at one end into the vacuum container 20 and at the other end is connected to the atmosphere 26. Dirty liquid 15 is conveyed into the vacuum container 20 through the suction line 16 and a feed line 27, which is connected at one end to the intake connection 17 of the processing device 2 and at the other end opens into the vacuum container 20.

The vacuum container 20 additionally serves to preclean the dirty liquid 15. The solids present in the dirty liquid 15 due to the abraded material of the substrate 13 settle out as sedimented solids 28 at the bottom of the vacuum container 20 due to gravity. Above the sedimented solids 28 there is precleaned dirty liquid 29.

A filter element 30, which is connected by a connecting line 31 to the vacuum container 20, is arranged in the second container 21. The part of the connecting line 31 protruding into the vacuum container 20 is designed as a riser line at a distance from the bottom of the vacuum container 20 so that the sedimented solids 28, which have settled out due to gravity, do not enter the filter element 30. A device 32 for generating a high pressure, which is referred to below as the high-pressure device and is embodied as a pressure pump, for example, is arranged in the connecting line 31. The high-pressure device 32 generates a high pressure, which is between 1 and 6 bar, for example. The second container 21 is also referred to as the pressurized container.

Due to the high pressure, the precleaned dirty liquid 29 flows out of the vacuum container 20 into the filter element 30 through the connecting line 31. A nonreturn valve 34, which prevents the precleaned dirty liquid 29 from flowing back into the vacuum container 20, is situated upstream from the high-pressure device 32 in one direction of flow 33 in the connecting line 31.

Because of the high pressure in the filter element 30, the precleaned dirty liquid 29 flows into the pressurized container 21 through the filter element 30 in one direction of flow 35. Solids contained in the precleaned dirty liquid 29 settle out due to gravity at the bottom of the filter element 30 or they are captured in the filter element 30. Recycled cooling and rinsing liquid 36, which can be supplied to the core drilling device 1, collects in the pressurized container 21, so the cycle is closed. Due to the pressure difference, the recycled cooling and rinsing liquid 36 flows in one direction of flow 37 through a discharge line 38, which opens at one end into the pressurized container 21 and at the other end is connected to the outlet connection 10 of the processing device 2 and through the supply line 9 into the core drilling device 1.

The dirty liquid 15 or the precleaned dirty liquid 29 flows through the feed line 27, the connecting line 31, the first bypass line 40, the first control valve 42 and the high-pressure device 32. Since the dirty liquid 15 and the precleaned dirty liquid 29 contain solids that can clog the lines, the first control valve 42, and the high-pressure device 32, regular cleaning of the lines 27, 31, 40, of the first control valve 42, and of the high-pressure device 32 is necessary. The feed lines and connecting lines 27, 31, 40, the first control valve 42, and the high-pressure device 32 are cleaned via a flow bypass of the recycled cooling and rinsing liquid 36 and the precleaned dirty liquid 29 in a cleaning operation of the processing device 2.

The inventive processing device 2 has a first bypass line 40 and a second bypass line 41. The first bypass line 40 establishes a connection between the connecting line 31 and the feed line 27 and branches off the connecting line 31 downstream from the high-pressure device 32, as seen in the direction of flow 33. The first bypass line 40 opens into the feed line 27 directly downstream from the inlet connection 17 of the processing device 2, so that the feed line 27 is completely rinsed. The second bypass line 41 establishes a connection between the discharge line 38 and the connecting line 31 and branches off from the discharge line 38 upstream from the outlet connection 10, as seen in the direction of flow 37, and upstream from the high-pressure device 32 and the nonreturn valve 34, as seen in the direction of flow 31, into the connecting line 31.

For flow diversion of the recycled cooling and rinsing liquid 36 and the precleaned dirty liquid 29 via the first and second bypass lines 40, 41, three control valves 42, 43, 44 are provided, each being adjustable between an open state and a closed state by a control device 45. The first bypass line 40 can be closed by the first control valve 42, which is also referred to as the cleaning valve. The first control valve 42 is situated at the inlet of the first bypass line 40. The supply of recycled cooling and rinsing liquid 36 into the supply line 9 and the core drilling device 1 is adjustable via the second control valve 43, which is downstream from the second bypass line 41, as seen in the direction of flow 37. The third control valve 44 is arranged in the second bypass line 41 and ensures that the second bypass line 41 is closable. To monitor the pressure generated by the high-pressure device 32, a pressure switch 46, which is connected to the control device 45, is arranged in the discharge line 38.

The processing device 2 has two different operating modes, a drilling operation and a cleaning operation. In the drilling operation, the processing device 2 feeds recycled cooling and rinsing liquid 36 to the core drilling device 1 and removes the dirty liquid 15 by suction from the collecting device 14. The first and second bypass lines 40, 41 are sealed via the first and third control valves 42, 44, both of which are in a closed state, during drilling operation. The second control valve 43 is in the open state, so that the recycled cooling and rinsing liquid 36 can flow through the second control valve 43 into the supply line 9.

The cleaning operation of the processing device 2 takes place automatically in preselectable intervals of time or as a function of certain boundary conditions, for example, if the processing device is in a standby mode. Cleaning of the feed line 27, the first bypass line 40, the first control valve 42 as well as the connecting line 31 and the high-pressure device 32 takes place in multiple stages.

In a first stage, there is a coarse prerinsing of the first control valve 42 as well as the first bypass line 40 and the feed line 27. The control device 45 closes the second control valve 43 in the discharge line 38 and thus interrupts the feed of recycled cooling and rinsing liquid 36 from the processing device 2 to the core drilling device 1.

The pressure switch 46 measures the pressure in the discharge line 38 and delivers a switch pulse to the control device 45 on exceeding a preset pressure level. Alternatively, the switch pulse may take place after a preset interval of time has elapsed. The control device 45 opens the first control valve 42 in the first bypass line 40 for a short interval of time. During this interval of time, the precleaned dirty liquid 29 flows out of the connecting line 31 and into the first bypass line 40 and from there into the feed line 27 and next into the vacuum container 20. After the interval of time has elapsed, the control unit 45 closes the first control valve 42.

In a second step of the rinse program, the high-pressure device 32 and the connecting line 31 are cleaned using recycled cooling and rinsing liquid. The control unit 45 opens the third control valve 44 with an active high-pressure device 32. The first and second control valves 42, 43 are in a closed state. The recycled cooling and rinsing liquid 36 flows through the discharge line 38 into the second bypass line 41 in the direction of flow 37 and from there flows back through the high-pressure device 32 into the second container 21 in the direction opposite the direction of flow 33. The circuit is closed here via the filter element 30 and the discharge line 38.

In a third rinse step, the first control valve 42 is cleaned with recycled cooling and rinsing liquid 36. The control unit 45 opens the first control valve 42 in the first bypass line 40 for a short interval of time. In this interval of time, the recycled cooling and rinsing liquid 36 flows out of the connecting line 31 into the first bypass line 40 and from there into the feed line 27 and next into the vacuum container 20. After the brief interval of time has elapsed, the control unit 45 closes the first control valve 42. Next the pressure is built up via the high-pressure device 32 for a certain interval of time and the first control valve 42 is opened very briefly. This procedure is repeated a few times until the first control valve 42 has been adequately rinsed with recycled cooling and rinsing liquid 36.

At the end of the third rinse step, the high-pressure device 32 is turned off. The recycled cooling and rinsing liquid 36 remaining in the discharge line 38 and the second bypass line 41 flows through the connecting line 31 back into the vacuum container 20 and thereby rinses the connecting line.

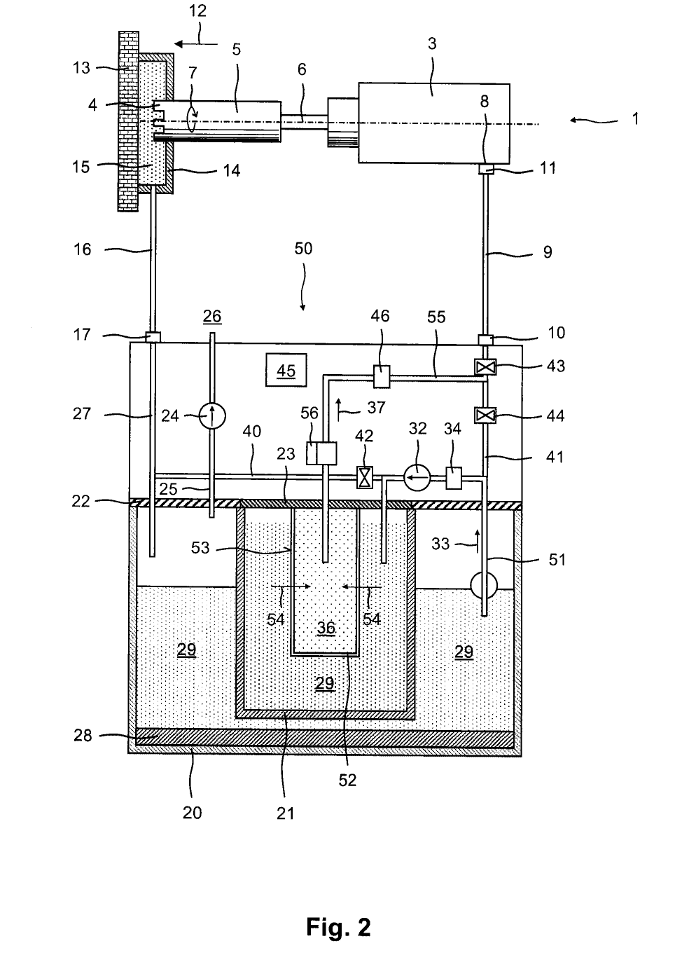

FIG. 2 shows the core drilling device from FIG. 1 with a second embodiment of an inventive processing device 50 for processing a cooling and rinsing liquid.

The processing device 50 differs from the processing device 2 shown in FIG. 1 in that during a drilling operation, the filter element is arranged downstream from the pressurized container 21, as seen in the direction of flow. With the aid of the vacuum device 24, the dirty liquid 15 is conveyed into the vacuum container 20, which performs a precleaning of the dirty liquid 15.

The vacuum container 20 is connected by a connecting line 51 to the pressurized container 21. In order for the solids 28 that have already sedimented due to gravity not to enter the pressurized container 21, the part of the connecting line 51 protruding into the vacuum container 20 is designed as a riser line at a distance from the bottom of the vacuum container 20. A high-pressure device 32 is also arranged in the connecting line 51.

A filter element 52, which is in contact at an outside surface 53 with the precleaned dirty liquid 29, is arranged in the pressurized container 21. Because of the high pressure prevailing in the pressurized container, the precleaned dirty liquid 29 flows through the outside surface 53 along a direction of flow 54 into the interior of the filter element 52. Solids present in the precleaned dirty liquid 29 remain captured on the filter element 52. The recycled cooling and rinsing liquid 36 collected in the interior of the filter element 52 can be supplied to the core drilling device 2. The filter element 52 is connected via the discharge line 55 to the outlet connection 10 of the processing device 50. The recycled cooling and rinsing liquid 36 flows through the discharge line 55 and the supply line 9 into the machine unit 3.

Furthermore, a diaphragm pressure reservoir 56 is also provided in the discharge line 55. The diaphragm pressure reservoir 56 consists of a first chamber, which is separated from a second chamber via a diaphragm. The first and second chambers are filled with different media. Air which is compressible under the influence of pressure is in the first chamber. The second chamber is filled with cooling and rinsing liquid, which is not compressible under the influence of pressure. The performance of the diaphragm pressure reservoir is selected so that the diaphragm pressure reservoir can store a sufficient quantity of cooling and rinsing liquid 36 sufficient to clean the filter element 52 and support the rinse program.

The feed line 27, the connecting line 51 and the high-pressure device 32, the first bypass line 40 and the first control valve 42 of the processing device 50 are cleaned by a method similar to that used in the cleaning of the processing device 2 with the aid of the bypass lines 40, 41 and the control valves 42, 43, 44.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for processing a cooling and rinsing liquid from a dirty liquid, comprising:
a feed line;
a first container connected to the feed line;
a discharge line;
a second container connected to the discharge line;
a filter element arranged in the second container;
a connecting line connecting the first and the second containers; and
a bypass line connecting the discharge line to the connecting line.

2. The device according to claim 1, wherein the bypass line has a first control valve, wherein the first control valve is adjustable by a control unit between an open state where a flow can pass through the first control valve and a closed state where the flow cannot pass through the first control valve.

3. The device according to claim 1, wherein the discharge line has a second control valve, wherein the second control valve is adjustable by a control unit between an open state where a flow can pass through the second control valve and a closed state where the flow cannot pass through the second control valve, and wherein the second control valve is arranged downstream from the bypass line in a first direction of flow.

4. The device according to claim 1, wherein the second container cooperates with a high-pressure device arranged in the connecting line and wherein the bypass line opens into the connecting line upstream from the high-pressure device in a second direction of flow.

5. The device according to claim 1, further comprising a second bypass line which connects the connecting line to the feed line.

6. The device according to claim 5, wherein the second bypass line has a third control valve such that the third control valve is adjustable by a control unit between an open state where flow can pass through the third control valve and a closed state where flow cannot pass through the third control valve.

7. The device according to claim 1, wherein the filter element is arranged upstream from the second container in a third direction of flow.

8. The device according to claim 1, wherein the filter element is arranged downstream from the second container in a fourth direction of flow.

9. The device according to claim 1, further comprising a pressure switch in the discharge line.

10. The device according to claim 1, further comprising a diaphragm pressure reservoir in the discharge line.

11. A method for processing a cooling and rinsing liquid in a processing device, wherein the processing device includes:
a feed line;
a first container connected to the feed line;
a discharge line with a first control valve;
a second container connected to the discharge line;
a connecting line connecting the first and the second containers; and
a bypass line connecting the discharge line to the connecting line, wherein the bypass line has a second control valve;
and comprising the steps of:
closing the first control valve and opening the second control valve such that the cooling and rinsing liquid flows through the bypass line.
